(19) United States
(12) Patent Application Publication
(10) Pub. No.: US 2007/0064008 A1
(43) Pub. Date: Mar. 22, 2007

(54) Image display system and method

(76) Inventor: Winthrop D. Childers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/226,109

(22) Filed: Sep. 14, 2005

(51) Int. Cl. G09G 5/02

(52) U.S. Cl. 345/589; 345/643

(57) ABSTRACT

Disclosed are embodiments of a system and method for processing an image. An image processing unit includes a processor unit and a control unit. The processor unit is configured to receive an incoming video signal and to generate information indicative of the video signal. The control unit is configured to generate first control signals that define bit planes manifested on a spatial light modulator. The control unit is further configured to generate second control signals that define an illumination characteristic of light received by the spatial light modulator from a solid state light source for each of the bit planes. The illumination intensity characteristic is selected based upon the information indicative of the video signal.

### BACKGROUND

Various techniques for displaying images exist. One such approach is accomplished with the use of digital image projectors or digital light processing (DLP)-based projectors. Typically, such projectors are either optimized for high color saturation (RGB color wheels) or are optimized for high brightness (RGBW color wheels). Where the projector application is displaying video images, such as movies, high color saturation is more appropriate. Where the projector application is displaying graphical images, such as information displays, high brightness is more appropriate.

Such single fixed-gamut projectors can result in decreased quality of the projected image in applications where both types of images are displayed. Some projectors have addressed this issue by providing a two color wheel configuration. In such dual-gamut solutions the system can swap color wheels dependant on the application. This solution with multiple color wheels, however, adds significantly to cost and complexity.

### SUMMARY

Exemplary embodiments of the present invention include a system and method for processing an image. An image processing unit includes a processor unit and a control unit. The processor unit is configured to receive an incoming video signal and to generate information indicative of the video signal. The control unit is configured to generate first control signals that define bit planes manifested on a spatial light modulator. The control unit is further configured to generate second control signals that define an illumination characteristic of light received by the spatial light modulator from a solid state light source for each of the bit planes. The illumination intensity characteristic is selected based upon the information indicative of the video signal.

### BRIEF DESCRIPTION OF THE DRAWINGS

FIG. 1 illustrates a schematic diagram of a system for displaying images according to an embodiment of the present invention.

FIG. 2 is a flow diagram illustrating a process used by an image display system in accordance with one embodiment of the present invention.

FIGS. 3-7 are exemplary frame periods for an image display system in accordance with various embodiments of the present invention.

### DETAILED DESCRIPTION

In the following Detailed Description, reference is made to the accompanying drawings, which form a part hereof, and in which is shown by way of illustration specific embodiments in which the invention can be practiced. It is to be understood that other embodiments can be utilized and structural or logical changes can be made without departing from the scope of the present invention. The following Detailed Description, therefore, is not to be taken in a limiting sense, and the scope of the present invention is defined by the appended claims.

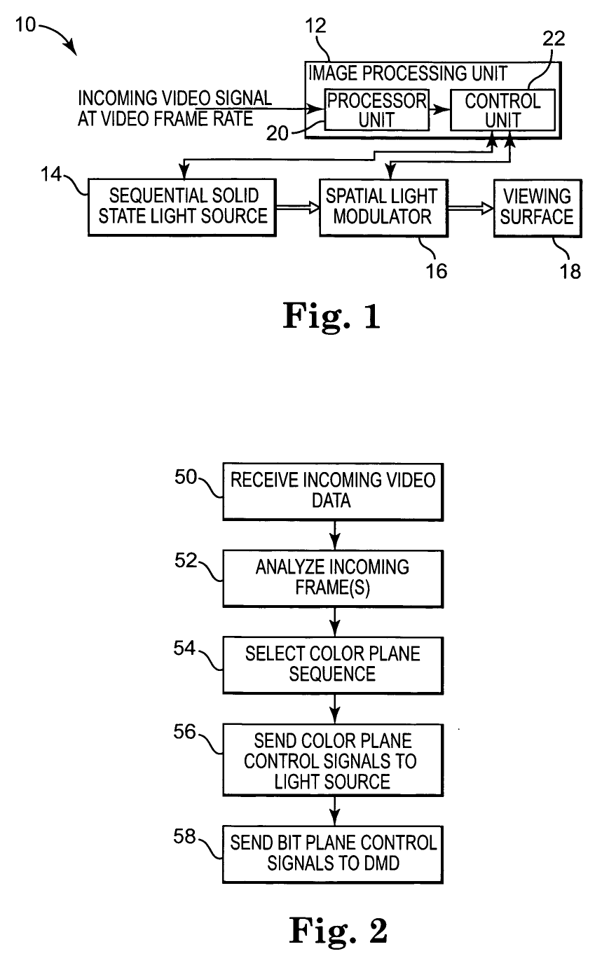

FIG. 1 illustrates image display system 10 in accordance with one embodiment of the present invention. In one example, image display system 10, includes image processing unit 12, sequential solid state light source 14, spatial light modulator 16 and viewing surface 18. In one example, image display system 10 is a digital projector that is used to project an image. Image processing unit 12 receives an incoming video signal. The video signal has an associated video frame rate. Image processing unit 12 processes the video signal and then controls the sequential solid state light source 14 and spatial light modulator 16 in order to project the incoming video signal as an image on viewing surface 18.

In one embodiment, image processing unit 12 includes processor unit 20 and control unit 22. Processor unit 20 is configured to receive the incoming video signal and to generate image characteristic information indicative of the video signal. Control unit 22 is then configured to receive the image characteristic information indicative of the video signal and to generate control signals used to control solid state light source 14 and spatial light modulator 16. In this way, rather than being optimized for high color saturation or high brightness, image display system 10 in accordance with one embodiment of the invention provides an analysis of the characteristics of the video signal in order to provide optimized image frame and/or bit plane generation according to the characteristics of the video signal.

In one embodiment, sequential solid state light source 14 is a plurality of solid state light emitting diodes (LEDs). For example, in one case, sequential solid state light source 14 includes red LED(s), green LED(s), and blue LED(s). It can be appreciated that alternative and/or additional solid state light sources can be used generating colors such as white, cyan, yellow, magenta, among others. The solid state light source is optically configured to illuminate a pixel array formed in a surface of spatial light modulator 16.

In one embodiment, spatial light modulator 16 is a digital micro-mirror device (DMD). A DMD has an array of micro-mechanical display elements, each having a tiny mirror that is individually addressable with an electronic signal. Depending on the state of its addressing signal, each mirror tilts so that it either does or does not couple light to an image plane of viewing surface 18. Each of the mirrors is referred to as a “pixel element,” and the image each pixel element generates upon the viewing surface 18 can be referred to as a “pixel.” Generally, displaying pixel data is accomplished in part by loading memory cells connected to the pixel elements. Each memory cell receives one bit of data representing an on or off state of a pixel element. The image processing unit 12 is configured to maintain the pixel elements in their on or off states for a controlled duration.

The present invention can be applicable to other spatial light modulators 16 that are rapidly switchable between on and off states to define images on a viewing surface. Examples of other spatial light modulator technologies include LCOS (liquid crystal on silicon) and linear arrays of deflectable beams.

In one embodiment, the image processing unit 12 is configured to receive an incoming video signal and to convert that signal into a sequence of image frames. Each image frame defines primary color values for each pixel to be defined upon viewing surface 18. In one example, the color values would represent the intensity of red, green, and blue components of light to be displayed for each pixel displayed on viewing surface 18.

The image processing unit 12 is further configured to convert each image frame into a plurality of bit planes. Each of the plurality of bit planes defines an associated primary color and bit plane time period having a bit plane time duration. Within a bit plane time period, each pixel element of modulator 16 is either in an on or off state. Each bit plane time period further defines one or more time slices each having a time slice time period. When a bit plane time period is divided into more than one time slice, the time slices are temporally separated within a frame period. To define the primary color associated with the bit plane, the image processing unit 12 is configured to operate the solid state light source 14 to illuminate the spatial light modulator 16 with light having a spectral distribution that defines the primary color during the bit plane time period.

During the bit plane time period, an array of pixels corresponding to the array of pixel elements is cast upon viewing surface 18. For the array of pixels, there is a pixel having the primary color corresponding to each pixel element that is in the on state. There is a missing or black pixel for each pixel element that is in the off state.

In one embodiment, control unit 22 sends control signals to the solid state light source defining a sequence of states for the solid state light source. Each of the sequence of states defines an average intensity and a primary color of light that the solid state light source 14 provides to the array of pixel elements on spatial light modulator 16 during each bit plane time period.

In one embodiment, each of the sequences of states for the solid state light source 14 corresponds to one of the sequences of time slices that are each manifested on spatial light modulator 16, one time slice after another. During the sequence of time slices, the average intensity (averaged over the time slice time period) changes from one time slice to the next for one or more sequential pairs of time slices. During the sequence of time slices, a selection of a primary color of light that the solid state light source 14 provides changes from one time slice to the next for one or more sequential pairs of time slices.

In one embodiment, the control unit 22 sends control signals to the solid state light source 14 that defines a sequence of light pulses emitted by the solid state light source 14. A light pulse is defined as the light source 14 turning on for a brief duration and then off. A light pulse is characterized by an average intensity level, a primary color emitted, and a duration.

In one embodiment, each light pulse has a time duration that falls within one of the time slices. Stated another way, the solid state light source 14 turns on at the beginning or within the time slice time period and turns off at the end or within the time slice period so that the duration during which the solid state light source is on (the light pulse duration) falls within the time slice time period. For some time slices, there can be more than one light pulse emitted during each time slice time period.

To quantify the generation of bit planes, consider an example wherein the image frames are generated at 60 frames per second such that each frame lasts for approximately 16.67 milliseconds. To generate 24 bit color or 8 bits per primary color, a minimum of 8 bit planes need to be defined per primary color. The bit planes typically have time durations that vary in a binary manner, from the least significant bit (“LSB”) to the most significant bit (MSB).

Based upon this, it would be expected that the LSB for a given primary color would have a time duration of about one third of about 1/256^{th} of a frame period, or about 22 microseconds. This can result in an operational bottleneck due to the immense data rate and mirror frequency requirements for the system to position the mirrors for a bit plane. In one embodiment, this can be mitigated by modulating the light source within bit planes to extend the minimum duration requirement for bit planes.

Having a time-contiguous MSB can result in visual artifacts frame to frame. Therefore, dividing up the MSB over the frame period can be optimal. Stated another way, the most significant bit time period is divided up into non-contiguous or temporally separated time slices. For each most significant bit plane, the time slices are distributed or temporally spaced apart during the frame period.

An exemplary set of bit planes for a single primary color that takes the aforementioned factors into account is depicted in the following table:

| Bit | | Duration/Time | | |
|---|---|---|---|---|
| Plane | Weighting | Slice | No. of Slices | Avg. Intensity |
| 0 | 1 | 1 | 1 | 1 |
| 1 | 2 | 1 | 1 | 2 |
| 2 | 4 | 1 | 1 | 4 |
| 3 | 8 | 1 | 1 | 8 |
| 4 | 16 | 2 | 1 | 8 |
| 5 | 32 | 2 | 2 | 8 |
| 6 | 64 | 2 | 4 | 8 |
| 7 | 128 | 2 | 8 | 8 |

In this example, the entire frame period is divided up onto 19 time slices for each of red, green, and blue, or a total of 57 time slices. The least significant bit plane is generated in one time slice that is about 163 microseconds long. This is made possible by the variation in the average intensity adjustments for bit planes 0 to 3. In the example depicted in the table above, the most significant bit plane (bit 7) time period is divided up into 8 separate time slices that can be temporally separated over the frame period.

The following defines terms used in the table.

Weighting: The weighting depicted above is binary, but this need not be the case. The weighting factor is proportional to the per pixel contribution to the average intensity during a frame period when that pixel is turned ON.

Duration/Time Slice: The time duration of each time slice. For the case where each of three primary colors are handled equally and for a 60 hertz frame rate, the shortest duration time slice (for bit planes 0-3) would have a duration of about 163 microseconds.

No. of Slices: How many time slices are required to provide that significance of bit. Stated another way, this is the number of temporally spaced time slices utilized to provide the bit plane time period.

Avg. Intensity: Average intensity of light received by the DMD from the solid state light source during each time slice for that bit. This intensity level can be achieved by varying the actual intensity of the light source or by varying the duty cycle (percentage of the duration of the bit plane for which the light source is ON) during the bit plane time period.

To avoid various visual artifacts, it is best to temporally separate the most significant bits for each primary color. Keeping this in mind, the following is an exemplary temporal sequence of time slices during a frame period based on the earlier table:

7R,7G,7B,6R,6G,6B,7R,7G,7B,4R,4G,4B,7R,7G,7B,3R,3G,3B,2R,2G,2B ,1R,1G,1B,0R,0G,0B,6R,6G,6B,7R,7G,7B,5R,5G,5B,7R,7G,7B,6R,6G,6B 7R,7G,7B,5R,5G,5B,7R,7G,7B,6R,6G,6B 7R,7G,7B

In this example, 6R is indicative of one time slice of bit 6 for red, 3B means bit 3 for blue, etc. As discussed earlier, bits 7, 6, and 5 for each primary color are divided up into 8, 4, and 2 temporally separated time slices respectively. In this way the image processing unit 12 generates first control signals to define the bit planes such as those discussed above that are manifested upon spatial light modulator 16.

Image processing unit 12 is also configured to analyze the incoming video signal and in response to generate image characteristic information indicative of the incoming video signal. Based upon image characteristic information, the image processing unit sends second control signals that define an illumination characteristic of light received by the spatial light modulator 16 from solid state light source 14 for each bit plane. In one embodiment, the illumination characteristic of light defines the primary color and/or the average intensity of light received by the light modulator 16 during the bit plane time period defined by each bit plane.

The image processing unit 12 analyzes the incoming frames based on the characteristics of the frames in order to define the image characteristic information indicative of the video signal. In one embodiment, the image characteristic information is indicative of an illumination intensity characteristic of at least one of the incoming frames. In one case, the illumination intensity characteristic is an average luminance of light during a frame period, which can be measured in a variety of ways.

In one embodiment, image processing unit 12 analyzes incoming image frames based on a multi-frame aspect, and in another, on a frame-by-frame aspect. Alternatively, image processing unit 12 receives a select signal from the user of the projector indicative of an operating preference and produces image characteristic information from this user selection. For example, in one case the user increases brightness at the expense of color gamut in order to achieve a desired output. In still other embodiments, image characteristic information is produced from a combination of analysis of the incoming frames based on the characteristics and upon a user selection.

Once image processing unit 12 generates the image characteristic information, either from analyzing the incoming frames, from user selection, or a combination thereof, image processing unit 12 then generates bit plane control signals for the spatial light modulator 12 and the solid state light source 14 based upon the image characteristic information. The bit plane control signals include first control signals imparted to the spatial light modulator 16 and second control signals imparted to the solid state light source. The first set of control signals define a plurality of bit planes to be manifested upon the spatial light modulator. For each bit plane, the first set of control signals defines which pixel elements are in an ON or OFF state during the bit plane as well as the bit plane duration. The second set of control signals define a primary color (spectral distribution) and average intensity of light received by the spatial light modulator for each bit plane as discussed by the following examples.

In a first example, the second set of control signals defines an average intensity of light received by the spatial light modulator during a frame period. In this example, the image characteristic information may be indicative of the brightness of scene to be displayed by system 10. The image processing unit may then adjust the average intensity or duty cycle of the solid state light source during each image frame or a sequence of image frames.

In a second example, the second set of control signals defines an average intensity of light received by spatial light modulator 16 within each bit plane. In this second example, the solid state light source is turned off during pixel element transitions and is modulated rapidly enough to only be on during each bit plane.

In a third example, the image processing unit 12 defines what primary colors are utilized during a frame period. For example, additional primary colors beyond red, green, and blue can be utilized. This may be important if a scene to be displayed is dominated by a particular color such as yellow, cyan, or white. In such a case, the signals define yellow, cyan, and/or white bit planes or time slices that may be interleaved with the RGB (red, green, and blue) bit planes.

In a fourth example, the image processing unit 12 defines a portion or fraction of the frame period duration to be allocated for each primary color. For a scene that is dominated by red, for instance, the combined duration of the red bit planes may utilize more than one third of the duration of the frame period.

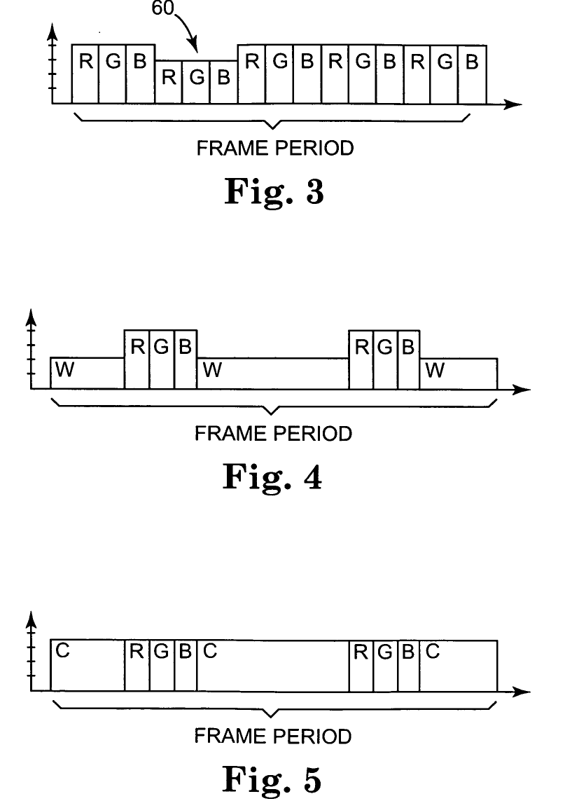

FIG. 2 illustrates a flow diagram of a process used by an image display system in accordance with one embodiment of the present invention. At step 50, incoming video data is received by image processing unit 12. At step 52, the incoming frames of the received video data are analyzed. The video data is converted into frames of data in the color space to be analyzed. In one embodiment, this would be primary colors R (red), G (green), and B (blue) values for each pixel. In other embodiments, other color spaces such as luminance and chrominance may be utilized. Alternative primary colors such as white, yellow, and cyan may be computed on a per pixel basis. One way to compute the white value is to take the minimum of the red, green, and blue values. One way to compute the yellow value is to take the minimum of red and green values.

Analyzing the frame can be done by histogram over the frame, average intensity over the frame, maximum value over the frame, or other methods. The following are some examples:

In a first example, the color space analyzed is luminance and chrominance. A histogram of the luminance is then analyzed for one or more video frames. A “dim” scene will tend to have dominant groupings or quantities of pixels having low luminance values. If the scene is “dim” then the average intensity or duty cycle of the solid state light source may be reduced for each bit plane. This enables a display system to have a higher contrast ratio when there is “leakage” of spatial light modulator pixels that are in the OFF state. In this first example, analysis of chrominance values may be utilized to determine what percentage of the frame period is to be occupied by each primary color.

In a second example, the color space analyzed is red, green, and blue. By generating a histogram of values for each of these primary colors, the amount of the frame period allocated to each primary color can be determined. In this example, the bit depth can be increased for the primary colors receiving a higher than one third allocation of the frame period. For example, a 24 bit system may have 10 bit green, 8 bit red, and 6 bit blue.

In a third example, the color space analyzed is RGB as in the second example but also one or more additional primary colors such as white are computed. For example, suppose that a histogram for white indicates a very strong white component of a frame. Then, the primary color white can be added and the color space recomputed to RGBW. Thus, a portion of the frame period is then allocated to white bit planes.

In another embodiment, the incoming frames of the received video data are analyzed based on the individual primary color values. In each case, the analysis of the video data in step 52 includes generating image characteristic information, whether in the form of histogram, individual color values, or other image characteristic information.

In step 54, a bit plane generation resulting in a time slice sequence is selected based upon the image characteristic information. In the example of the histogram analysis, the choice of bit plane primary colors can be selected from the histogram. For example, if there is a strong white component indicated by the histogram, then white bit planes can be utilized.

In step 56, once the color plane is selected, control signals are sent to the light source, such as solid state light source 14. In addition, in step 58, bit plane control signals are sent to the spatial light modulator, such as spatial light modulator 16.

In one embodiment, the bit plane generation chosen in step 54 further defines a LUT (look up table) that defines the bit planes. In one embodiment, the image processing unit 12 selects bit plane LUT based upon the image characteristic information. The bit plane LUT defines or determines how the color space for the image frame is converted into bit planes for the spatial light modulator and the solid state light source.

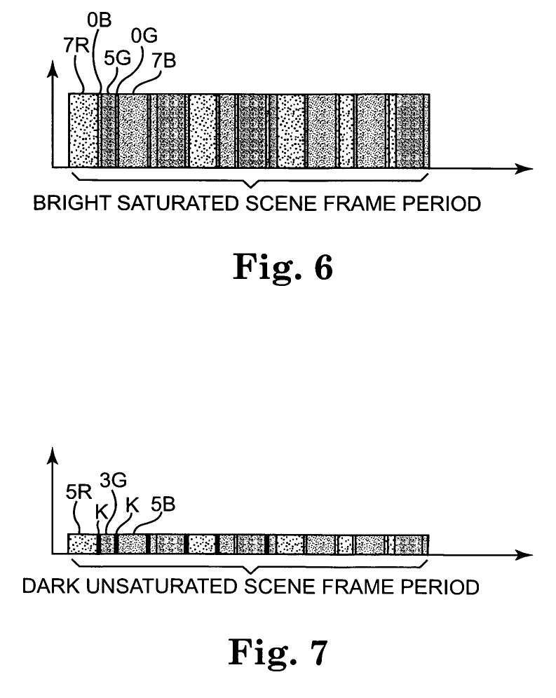

FIG. 3 illustrates an exemplary but greatly simplified bit plane generation during a frame period displayed by a system configured to receive and analyze image information. In this figure, the sequence of columns labeled RGBRGB . . . RGB depicts the sequence of time slices with their associated primary colors red, green, and blue. This is greatly simplified—the number of time slices is reduced and they are all depicted as having the same duration. The second RGB set 60 are depicted as shorter to depict a lower average light intensity either through pulse width modulation or by varying intensity of the solid state light source.

FIG. 4 illustrates a second time slice sequence (again greatly simplified). In this second example, a relatively dark scene is being generated that has low color saturation. Thus, the bit planes are dominated by low intensity white with only a few RGB time slices. This might be a sequence generated when histogram analysis of luminance and chrominance results in characteristic information indicative of a low light level and low color saturation. Again, the number of time slices illustrated is reduced for simplicity.

In one embodiment, spatial light modulator 16 will have some leakage in the OFF state. This leakage will tend to lower contrast ratio. In this way, reducing average intensity sent to the screen during each bit plane and then boosting the time duration of each time slice will increase contrast ratio.

FIG. 5 illustrates a third time slice sequence (again greatly simplified). In this third example, a scene is being generated that has a very large cyan (designated as C in the figure) component. An efficient way to generate this scene is to utilize mostly cyan bit planes (that can be generated, for example, by turning a red and blue solid state light source on at the same time.

In some embodiments of the image processing system, the analysis of the received video data will indicate a need for large changes in the time slice color sequence. This can occur, for example, when there are significant scene changes from frame to frame as the video data is received.

For example, there will be substantial changes when a bright scene changes to a night scene, and this can require a large change in color plane generation from one frame to the next. When a scene starts a fully saturated scene with fairly balanced colors, standard, full-intensity RGB time slices might be used, such as those illustrated in FIG. 6. Although illustrated in gray-scale, FIG. 6 illustrates the following time slice sequence (the first several of which are labeled in the figure):
7R, 0B, 5G, 0G, 7B, 0R, 4B, 7G, 1B, 7R, 1G, 5B, 2B, 7G, 1R, 4G, 6R, 2G, 7B, 2R, 5R, 3G, 6B, 3R, 4R, 6G, 3B.
   where 7R=bit 7 time slice (the most significant bit) for red where bit 7 is divided into two time slices, 0B=bit 0 (the least significant bit for blue, 5G=bit 5 for green, etc.
   In the bright saturated scene frame period illustrated in FIG. 6, bit 7 is repeated twice during the frame period.

Now, when the scene changes from this scene to a dark scene, reduced-intensity RGB time slices might be used, such as those illustrated in FIG. 7. The frame period above depicts a 75% reduction in the intensity for the RGB light source. In order to provide a given color value, the new lookup table must compensate. In this case, bits 6 and 7 are eliminated and then bits 0 to 5 are utilized. Again, although illustrated in gray-scale, FIG. 7 illustrates the following time slice sequence (the first several of which are labeled in the figure):
5R, K, 3G, K, 5B, K, 2B, 5G, K, 5R, K, 3B, 0B, 5G, K, 2G, 4R, 0G, 5B, 0R, 3R, 1G, 4B, 1R, 2R, 4G, 1B.

In this case, the least two significant bits are shifted to black (indicated by K) and all other bits are shifted downward by two. This has the effect of increasing the time duration for each time slice which compensates for the reduced average intensity of the LEDS. Note that the intensity reduction of the LEDS can be achieved by rapid pulse width modulation so the timing diagrams in the Figures are only one of many illustrative examples of how to achieve the reduced intensity.

Another example of a scene change is a sudden change to a scene with bright white or generally unsaturated objects. This can be achieved by including the insertion of white planes, such as illustrated (in greatly simplified form) in FIG. 4 above. White time slices can be generated by having RGB all on at once.

Scene changes that will cause large changes in color plane generation can also occur gradually. When a scene gradually changes, then the color planes may need to be adjusted gradually or not at all until the next scene change. In one case, the bit planes can be stretched as a scene darkens if the LEDS are gradually decreased in intensity. The time stretching can be accomplished by dropping the LSBs after dithering. Then, the binary weightings are adjusted in an analog manner during a sequence of frames.

In cases where the color is well balanced, using RGB color planes can be optimal. For some scenes, RGBW or adding cyan, yellow, and/or magenta can be used instread. Generally, a change to new primary colors will tend to only be done between scenes within a video sequence.

Note again that FIGS. 3-7 may be simplified versions of a true bit plane timing diagram that is actually used. The timing diagram actually used may have 50 or more time slices.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An image processing unit comprising:
a processor unit configured to receive an incoming video signal and to generate image characteristic information indicative of the video signal; and
a control unit configured to generate first control signals that define bit planes from the video signal for a spatial light modulator and further configured to generate second control signals that define an illumination characteristic of light received by the spatial light modulator from a solid state light source for the bit planes;
wherein the illumination characteristic is selected based upon the image characteristic information.

2. The image processing unit of claim 1, wherein the spatial light modulator includes an array of pixel elements, wherein each of the bit planes defines a bit plane time period and a binary state of each of the array of pixel elements, and wherein each binary state is either an on or an off pixel element state during the bit plane time period.

3. The image processor of claim 2, wherein each of the bit plane time periods includes one or more time slices, and the second control signal defines a state of the solid state light source during each of the time slices.

4. The image processor of claim 3, wherein the second control signal defines a primary color selection of light illuminating the spatial light modulator during each of the time slices and wherein the primary color selection changes for one or more pairs of time slices in a sequence.

5. The image processing unit of claim 1, wherein the second control signals define a sequence of light pulses emitted by the solid state light source.

6. The image processing unit of claim 5, wherein each of the bit plane time periods includes one or more time slice time periods, and each of the sequence of light pulses falls within one of the time slice time periods and wherein one or more time slice time periods each contains two or more light pulses.

7. The image processing unit of claim 1, wherein the image characteristic information is indicative of an intensity characteristic of at least one video frame of the video signal.

8. The image processing unit of claim 1, wherein the illumination characteristic defines average illumination intensity and durations of at least some of the bit planes.

9. The image processing unit of claim 1, wherein the illumination characteristic defines a selection of which primary colors are utilized to define bit planes during a frame period.

10. The image processing unit of claim 9, wherein the primary colors include colors selected from a set comprising red, green, blue, white, yellow, cyan, magenta, and orange.

11. The image processing unit of claim 9, wherein the selection of which primary colors to be utilized includes a set of standard primary colors and an additional added primary color selected from a group consisting of cyan, yellow, magenta, orange, violet, and white.

12. The image processing unit of claim 1, wherein the image characteristic information is indicative of a relative balance of primary colors in one or more image frames.

13. The image processing unit of claim 1, wherein the bit planes include a set of bit planes for each of a set of primary colors and the illumination intensity characteristic defines the allocation of a frame period to each of the set of primary colors.

14. The image processing unit of claim 1, wherein the first control signals define bit planes manifested over an area of the spatial light modulator wherein each of the bit planes has a time duration within a frame period.

15. The image processing unit of claim 14, wherein the signal passed to the solid state light sources defines a primary color for each of the bit planes, and wherein the primary colors are displayed during a frame period and wherein each primary color is substantially distributed across the majority of the duration of the frame period.

16. The image processing unit of claim 1, wherein the second control signals passed to the solid state modulator cause modulation of the light source within a time duration of a bit plane.

17. The image processing unit of claim 1 further configured to analyze an added primary color component of the video signal that is a combination of a standard set of primary colors and to determine whether to utilize bit planes of the added primary color.

18. An image processing unit comprising:
processor means for receiving an incoming video frame and for generating image characteristic information indicative of an intensity parameter of the incoming video frame; and
control means for generating bit plane control signals defining bit planes manifested on a spatial light modulator and for generating intensity control signals defining an intensity characteristic of light generated by a solid state light source for each of the bit planes based upon the intensity parameter.

19. The image processing unit of claim 18, wherein the spatial light modulator includes an array of pixel elements that each have an on state and an off state, each of the bit planes defines a bit plane time period and whether each of the pixel elements are in the on state or the off state during the bit plane time period.

20. The image processing unit of claim 19 wherein the intensity control signals define a series of light pulses delivered from the solid state light source to the spatial light modulator, wherein each of the series of light pulses corresponds to one of the bit planes, and wherein each of the series of light pulses is temporally contained within one of the bit plane time periods.

21. The image processing unit of claim 18, wherein control unit defines a bit weighting factor for the bit planes based upon the intensity parameter.

22. The image processing unit of claim 18, wherein control unit selects a bit plane source lookup table based on the intensity parameter.

23. The image processing unit of claim 18, wherein the intensity parameter is selected from a group of parameters comprising an average pixel intensity, a maximum pixel intensity, an intensity histogram, and an intensity aspect of each primary color.

24. An image display system comprising:
an image processing unit configured to receive an incoming video signal and to generate information indicative of the video signal;
a sequential solid state light source coupled to the image processing unit, the sequential solid state light source configured to generate light having an illumination intensity characteristic; and
a spatial light modulator coupled to the sequential solid state light source and to the image processing unit;
wherein the image processing unit sends a first control signal to the spatial light modulator for controlling generation of bit planes displayed by the spatial light modulator and wherein the image processing unit sends a second control signal that is based upon the information indicative of the video signal to the solid state light source for controlling the illumination intensity characteristic of light received by the spatial light modulator for each of the bit planes.

25. The image display system of claim 24, wherein the information indicative of the video signal is indicative of an intensity characteristic of at least one video frame of the video signal.

26. The image display system of claim 24, wherein the illumination intensity characteristic defines average illumination intensity and durations of at least some of the bit planes.

27. The image display system of claim 24, wherein the illumination intensity characteristic defines a selection of which primary colors are utilized to define bit planes during a frame period and wherein the primary colors includes colors selected from a set comprising red, green, blue, white, yellow, cyan, magenta, and orange.

28. An method for processing an image comprising:
receiving an incoming video video frame;
generating image characteristic information indicative of an intensity parameter of the incoming video frame;
generating bit plane control signals defining bit planes manifested on a spatial light modulator;
generating intensity control signals defining an intensity characteristic of light generated by a solid state light source for each of the bit planes based upon the intensity parameter.

29. The method of claim 28, wherein the spatial light modulator includes an array of pixel elements that each have an on state and an off state, each of the bit planes defines a bit plane time period and whether each of the pixel elements are in the on state or the off state during the bit plane time period.

30. The method of claim 29 wherein the intensity control signals define a series of light pulses delivered from the solid state light source to the spatial light modulator, wherein each of the series of light pulses corresponds to one of the bit planes, and wherein each of the series of light pulses is temporally contained within one of the bit plane time periods.
